(19) United States
(12) Patent Application Publication
(10) Pub. No.: US 2013/0279730 A1
(43) Pub. Date: Oct. 24, 2013

(54) DISPLAY DEVICE

(71) Applicant: Hideaki Tanaka, Osaka-shi (JP)

(72) Inventor: Hideaki Tanaka, Osaka-shi (JP)

(73) Assignee: SHARP KABUSHIKI KAISHA, Osaka-shi, Osaka (JP)

(21) Appl. No.: 13/977,463

(22) PCT Filed: Dec. 20, 2011
(86) PCT No.: PCT/JP2011/079450

§ 371 Date: Jun. 28, 2013

(30) Foreign Application Priority Data
Jan. 7, 2011 (JP) 2011-001614
Dec. 16, 2011 (JP) 2011-275149

(51) Int. Cl. H04R 1/02

(52) U.S. Cl. CPC H04R 1/021
USPC 381/333

(57) ABSTRACT

The present invention outputs a sound with favorable sound quality and volume, while inhibiting degradation in frequency characteristics and reduction in volume, with a structure in which a speaker is provided on the rear-face side of a display panel. A display device includes: a display panel that displays an image; a housing to which the display panel is attached; and a speaker provided inside the housing on the rear-face side of the display panel. The speaker axis (x) of the speaker is inclined toward the outside in the horizontal direction of the display panel with respect to the normal line (y) to the display surface of the display panel, and the directivity of the speaker is arranged outward and obliquely rearward of the display device. The housing has one or more sound output holes for outputting the sound emitted from the speaker to the outside, the sound output hole(s) being located more toward the outside than the speaker axis (x). The housing also has one or more tone-control sound output holes located more toward the inside in the horizontal direction of the display device than the sound output hole(s).

### TECHNICAL FIELD

The present invention relates to a display device, and more particularly to a display device in a low-profile configuration that is provided with a speaker on the rear-face side of a display panel.

### BACKGROUND OF THE INVENTION

For example, a display device in a low-profile configuration has been commonly used such as a low-profile television device or a tablet computer. Such a display device has almost the entire surface on the front side of a housing as a display screen of a display panel, and often has a significantly low-profile configuration in order to emphasize design and functionality.

The display device as described above has a problematic arranged configuration of a speaker for audio output. In the case of arranging a display screen on almost the entire surface on the front side of the display device, it is impossible to arrange the speaker on the front side of the display device. Therefore, the speaker has to be arranged on the rear-face side or the lateral-face side of the display panel.

Regarding the configuration of the speaker of the low-profile display device as described above, for example, Patent Document 1 discloses a speaker device in which a sound emitted by a speaker built in a housing of a flip phone is emitted to the outside through a sound hole provided on a lateral face of the housing on the lateral side of the speaker. The speaker device includes sound holes on front and lateral faces of the speaker. An annular pad is provided across the lateral face of the speaker provided with a lateral-face sound hole from a front face of the speaker in such a way as to wholly enclose a front-face sound hole and the lateral-face sound hole. An external space is formed where the annular pad and an inner face of the housing contact with each other and thereby sounds passing through the front-face sound hole are guided along the inner face of the housing to the lateral-face sound hole, then making the above sounds and sounds passing through the lateral-face sound hole join together in the vicinity of the lateral-face sound hole, thereafter guiding the sounds that joined together to a sound hole provided in the lateral face of the housing. Such a configuration may allow sound pressure of a speaker to be enhanced without increasing a mounting space and width of the speaker.

Further, Patent Document 2 discloses a portable terminal intended to allow reduction of characteristic degradation in sound output from a speaker, while thinning a device. In the portable terminal, a housing sound hole for outputting a sound emitted by the speaker is formed on a lateral face of a rear-face side case, and a speaker mounting portion is formed so as to come into contact with a lateral face on which the housing sound hole is formed.

The speaker includes a speaker sound hole in a protector for protecting the inside thereof. Additionally, cushioning materials are stuck to the protector in order to form a cavity between the protector and the rear-face side case, while the speaker is mounted on the speaker mounting portion. By utilizing the cavity between the protector and the rear-face side case as an acoustic transmitting space, degradation in sounds emitted by the speaker may be reduced.

### PRIOR ART DOCUMENT

### Patent Documents

Patent Document 1: Japanese Laid-Open Patent Publication No. 2007-215075
Patent Document 2: Japanese Laid-Open Patent Publication No. 2007-195011

### SUMMARY OF THE INVENTION

### Problem to be Solved by the Invention

For example, in a case where a speaker is arranged inside a housing to which a display panel is attached and a hole is provided on a rear face of the housing to emit a sound rearward a display device, the sound is diffracted from the rear of the housing to be transmitted to a user located in front of the display device.

Generally, a low-pitched sound with a low frequency has low directivity (straightness), while a high-pitch sound with a high frequency has high directivity. Therefore, in a case where a sound output hole for emitting a sound from a speaker to the outside is provided on a rear face of a housing as described above, the sound with a low frequency is easily transmitted to a user side, however, a diffraction amount of the sound with a high frequency to the front side is decreased, so that frequency characteristics and sound quality are degraded as well as being sounded with reduced volume at a front user position.

For a display device such as a low-profile television including an acoustic system comprised of speakers having a plurality of frequency characteristics, a device has been conventionally made to arrange a woofer on a rear face of the device for providing a sound with a low frequency in a large diffraction amount, which, however, has posed a problem that it is impossible to simply arrange a squawker or the like providing a sound with a medium and high frequency of about 500 Hz or more on the rear face, in view of directivity.

Therefore, a display device is required to include a configuration of speakers so as not to cause degradation in frequency characteristics and reduction in volume under restriction on design and functionality of arranging a display screen on almost the entire surface on the front side.

In both of the display devices in the portable terminals disclosed in the above-described Patent Documents 1 and 2, devices have been made for emitting sounds in the lateral direction of speakers, but are insufficient in light of a configuration to solve the problem of degradation in frequency characteristics and reduction in volume. Further, Patent Document 1 describes the device made for providing sound holes on front and lateral faces of a speaker for joining sounds together, however, mentions only the device for synthesizing sounds inside a housing, and no description has been given for a measure against the case of not allowing such a configuration to be provided inside the housing.

The present invention is devised in light of the above-described problems, and an object thereof is to provide a display device configured to output a sound with favorable sound quality and volume, while inhibiting degradation in frequency characteristics and reduction in volume in a configuration in which a speaker is provided on the rear-face side of a display panel.

### Means for Solving the Problem

To solve the above problems, a first technical means of the present invention is a display device, comprising: a display panel for displaying an image; a housing to which the display panel is attached; and a speaker provided inside the housing on a rear-face side of the display panel, wherein a speaker axis of the speaker is inclined toward the outside in a horizontal direction of the display panel with respect to a normal line to a display surface of the display panel, and a center of directivity of the speaker is arranged outward and obliquely rearward the display device; and the housing has one or more sound output holes for outputting a sound emitted from the speaker to the outside, the sound output hole being located at an outward position in the horizontal direction of the display panel with respect to the speaker axis.

A second technical means is the display device of the first technical means, wherein the housing has one or more auxiliary sound output holes on the inner side in the horizontal direction of the display device with respect to the sound output hole.

A third technical means is the display device of the second technical means, wherein an opening area of the auxiliary sound output hole is smaller than an opening area of the sound output hole.

A fourth technical means is the display device of the second or the third technical means, wherein the housing includes a rear-face wall portion arranged parallel to the display panel on a rear-face side of the display panel and a side wall portion that connects the rear-face wall portion and the display panel on a lateral side in the horizontal direction of the rear-face wall portion, and the sound output hole is provided on the side wall portion.

A fifth technical means is the display device of the fourth technical means, wherein the auxiliary sound output hole is provided on the rear-face wall portion.

A sixth technical means is the display device of any one of the second to the fifth technical means, wherein a central axis of the sound output hole specified by a wall surface shape around the sound output hole faces a lateral direction of the display device.

A seventh technical means is the display device of any one of the second to the sixth technical means, wherein a central axis of the auxiliary sound output hole specified by a wall surface shape around the auxiliary sound output hole faces the lateral direction of the display device.

An eighth technical means is the display device of the sixth or the seventh technical means, wherein an inclined portion by counterboring is included on an opening portion on an inward side of the housing of the sound output hole and/or the auxiliary sound output hole.

A ninth technical means is the display device of any one of the second to the eighth technical means, wherein the sound output hole and the auxiliary sound output hole are arranged within a region of the housing located in front of a diaphragm of the speaker, the region being in a shape corresponding to a shape of the diaphragm.

### Effect of the Invention

According to the present invention, it is possible to provide a display device configured to output a sound with favorable sound quality and volume, while inhibiting degradation in frequency characteristics and reduction in volume in a configuration in which a speaker is provided on the rear-face side of a display panel.

### BRIEF DESCRIPTION OF DRAWINGS

FIG. 1 is a diagram showing a conventional example for comparing to a configuration of a display device of the present invention.

FIG. 2 is a diagram showing a comparative example for comparing to the configuration of the display device of the present invention.

FIG. 3 is a diagram showing a measurement result of sound pressure of a sound output from a speaker in the configurations in FIG. 1 and FIG. 2.

FIG. 4 is a diagram showing an embodiment of the display device of the present invention.

FIG. 5 is a diagram showing a measurement result of sound pressure of a sound output from a speaker in a configuration of FIG. 4 in which a sound output hole is laterally provided.

FIG. 6 is a diagram showing another embodiment of the display device of the present invention.

FIG. 7 is a diagram showing a measurement result of sound pressure of a sound output from a speaker in a configuration shown in FIG. 6 in which a sound output hole and an auxiliary sound output hole are provided.

FIG. 8 is a diagram showing a more specific configuration example of an embodiment of the display device according to the present invention.

FIG. 9 is a back view in an embodiment of the display device according to the present invention.

FIG. 10 is a front view in an embodiment of the display device according to the present invention.

FIG. 11 is a diagram showing another configuration example of the sound output hole in the display device according to the present invention.

FIG. 12 is a diagram showing still another configuration example of the sound output hole in the display device according to the present invention.

FIG. 13 is a diagram showing yet still another configuration example of the sound output hole in the display device according to the present invention.

FIG. 14 is a diagram showing another configuration example of the sound output hole and the auxiliary sound output hole in the display device of the present invention.

FIG. 15 is a diagram showing still another configuration example of the sound output hole and the auxiliary sound output hole in the display device of the present invention.

FIG. 16 is a diagram showing a setting example of a shape of the auxiliary sound output hole in the display device according to the present invention.

FIG. 17 is a diagram showing yet still another configuration example of the auxiliary sound output hole.

### PREFERRED EMBODIMENT OF THE INVENTION

Hereinafter, description will be specifically given for embodiments according to a display device of the present invention, and a conventional example as well as a comparative example for giving an explanation by comparing to the present invention with reference to the accompanying drawings. Note that, like reference numerals represent parts having like functions in the entire drawings for explaining the present invention, and repetitive explanation thereof is omitted.

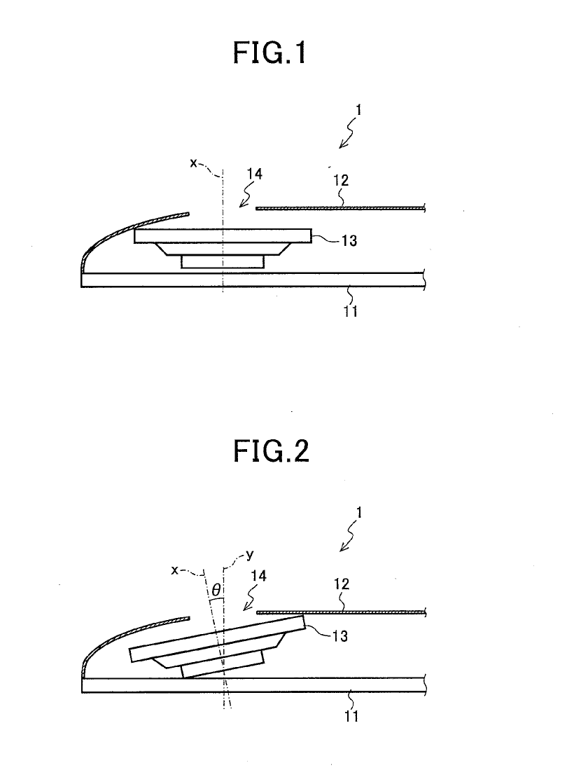

FIG. 1 and FIG. 2 are drawings showing a conventional example and a comparative example for comparing to a configuration of the display device of the present invention, and schematically show an arranged configuration of a display panel, a housing and a speaker of the display device, where FIG. 1 shows a conventional configuration example and FIG. 2 shows a comparative example for comparing to an embodiment of the present invention. FIG. 1 and FIG. 2 show a display device 1, a display panel 11, a housing (cabinet) 12 and a speaker 13.

The display device 1 is applicable to a low-profile communication terminal device or the like such as a low-profile television or a tablet computer in a portable type, and has, for example, a configuration in which the speaker 13 is arranged facing the rear-face side of a display panel because a display screen is arranged on almost the entire surface on the front side of the display device 1.

In such a low-profile display device, as shown in FIG. 1, the speaker 13 is arranged on the rear-face side of the display panel 11, however, the direction of the center of directivity thereof faces rearward the display device 1 in the conventional example. More specifically, a speaker axis (axis as the center of directivity of the speaker) (x) of the speaker 13 is almost coincident with a normal line direction of a display screen of the display panel 11. Additionally, in the direction of the center of directivity of the speaker 13, a sound output hole 14 is provided for outputting a sound emitted from the speaker 13 to the outside of the housing 12.

In this case, as described above, the sound emitted rearwards from the speaker 13 diffracted outside the housing 12 reaches a user who views a display screen, however, is provided in a less diffraction amount particularly in a high-frequency area with high directivity, thereby giving the impression of degradation in sound quality and reduction in volume.

On the other hand, like the comparative example of FIG. 2, it is possible to incline the speaker axis (x) of the speaker 13. In this case, the speaker axis (x) is inclined at only an angle θ with respect to a normal line (y) on the display screen of the display panel 11, for example. The speaker axis (x) is laterally inclined toward the outside in the horizontal direction of the display device. Thereby, a diffraction amount of the sound output from the speaker 13 to the front side is increased so that sound pressure increases on the front side.

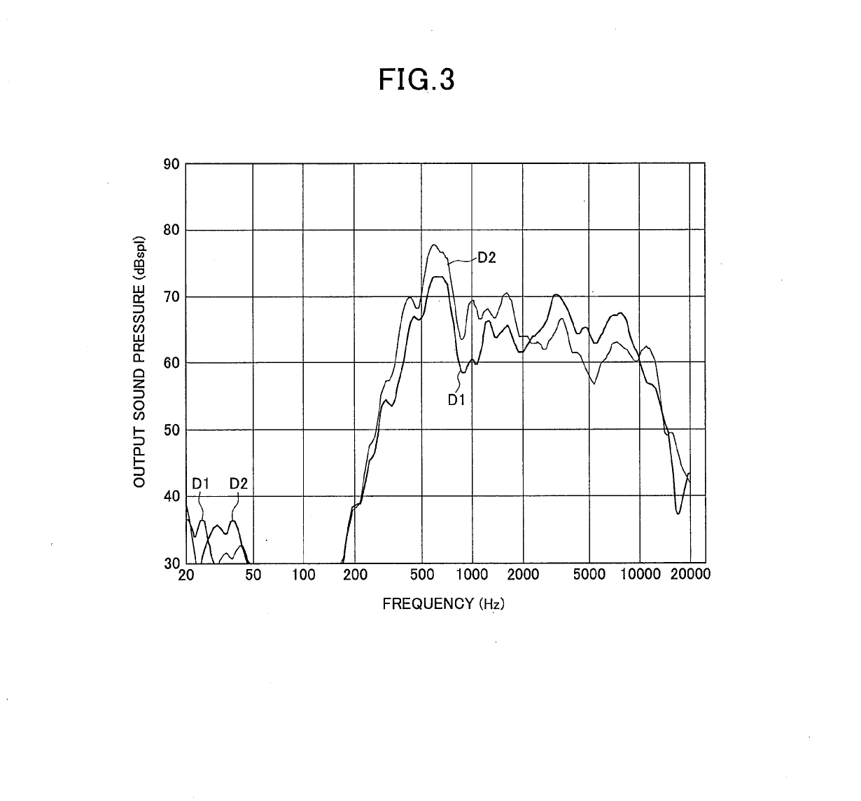

FIG. 3 is a diagram showing a measurement result of sound pressure of a sound output from a speaker in the configurations in FIG. 1 and FIG. 2, where a display device was placed on a stand to measure frequency characteristics of sound pressure output from the speaker on the front side of the display device (side where a display screen is viewable) without a wall near the rear-face side of the display device. In FIG. 3, D1 indicates frequency characteristics in a conventional common configuration shown in FIG. 1, and D2 indicates frequency characteristics of the inclined speaker axis (x) shown in FIG. 2. In the example, the angle θ of the speaker axis (x) with respect to the normal line (y) was 7°.

As shown in FIG. 3, the configuration of FIG. 2 in which the speaker axis (x) is inclined, sound pressure increases in about 2000 Hz or less compared to that in the configuration of FIG. 1 in which the speaker axis (x) is not inclined. That is, the speaker axis (x) is inclined toward the outside in the horizontal direction of the display device 1 so that a diffraction amount of sounds in an intermediate frequency domain of about 500 to 2000 Hz increases, thereby realizing that sound pressure in the intermediate frequency domain in front increases. However, only with simple inclination of the speaker axis (x), variation in the entire sound pressure is great, and frequency characteristics are seemingly degraded. Therefore, conventionally, it is impossible to realize improvement in sound quality and increase in volume by simply inclining the speaker axis (x) which has not been inclined with respect to the normal line (y).

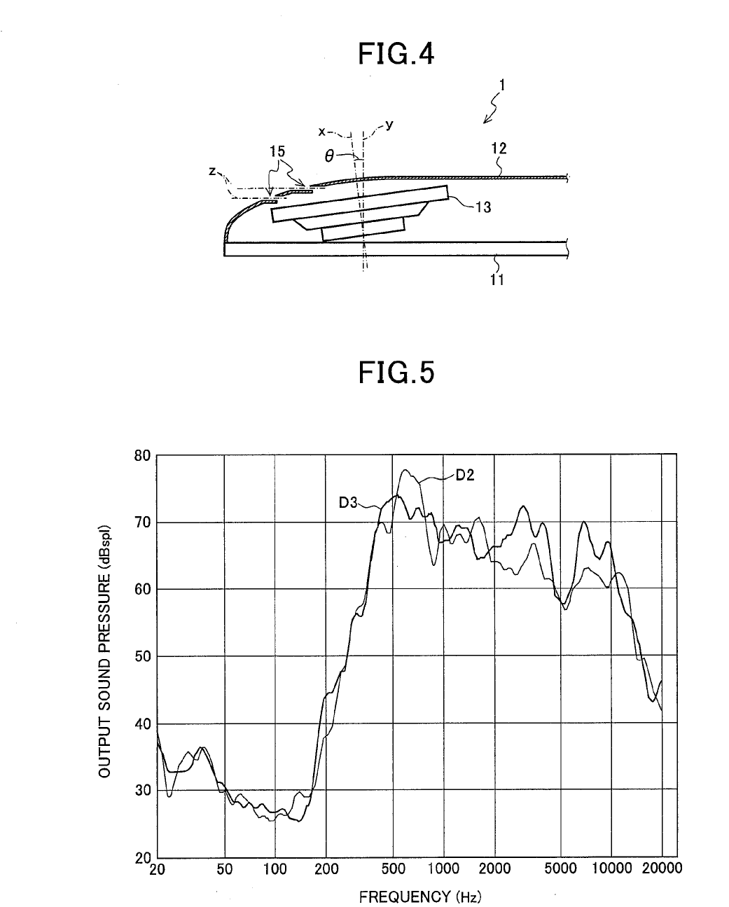

FIG. 4 is a diagram showing an embodiment of the display device of the present invention, and schematically shows the arranged configuration of the display panel, the housing and the speaker of the display device.

As described above, only simple inclination of the speaker axis (x) still caused disorder in frequency characteristics. As shown in FIG. 2, at the time, the sound output hole 14 was provided in a rear area in the center of the speaker 13 including the speaker axis (x). On the other hand, in an embodiment according to the present invention, one or more sound output holes 15 are provided at positions that are different from those in FIG. 1 and FIG. 2. The position of the sound output hole 15 is an outward position in the horizontal direction of the display device 1 with respect to the speaker axis (x) of the speaker 13. That is, the sound output hole 15 is provided not at a rearward position in the center of the speaker 13 but at a position displaced in the lateral direction of the device from the speaker axis (x).

Many of sounds emitted from the speaker 13 are propagated along the inner side of a wall surface on the rear-face side of the housing 13 to be emitted to the outside of the housing 13 from the sound output hole 15. At the time, the sound output hole 15 is located at the horizontally outward position with respect to the speaker axis (x), thus enhancing sound pressure toward the lateral direction of the display device 1 so that sounds diffracted to the front increase, thereby enhancing sound pressure characteristics at a front user position.

A shape of the sound output hole 15 is not particularly limited, and in the present example, a central axis (z) of the sound output hole 15 specified by a wall surface shape around the sound output hole 15 is formed so as to face the lateral direction of the display device 1. For example, in a case where space of the sound output hole 15 specified by a surrounding wall surface shape is in the shape of a column or a prism, long axial center of the column or the prism is the central axis (z). This configuration makes it possible to further laterally face directivity of the sound that is output from the speaker 13 to be emitted to the outside from the inside of the housing 12, while allowing enhancement in diffraction characteristics to the front side of the display device 1.

FIG. 5 is a diagram showing a measurement result of sound pressure of a sound output from a speaker in a configuration of FIG. 4 in which a sound output hole is laterally provided.

In FIG. 5, D3 indicates frequency characteristics of the configuration shown in FIG. 4 in which the sound output hole is laterally provided, and a detection result D2 in the configuration in FIG. 2 is displayed for comparison. D2 is the same as D2 shown in FIG. 3. Also in this example, the angle θ of the speaker axis (x) with respect to the normal line (y) is 7°.

As shown in FIG. 5, in a configuration in which the speaker axis (x) is inclined toward the outside in the horizontal direction of the display panel 11 with respect to the normal line (y) on a display surface of the display panel, the sound output hole 15 is provided at a horizontally outward position with respect to the speaker axis (x), so that it is possible to reduce variation particularly in a frequency band of about 500 Hz to 3 kHz, thereby totally showing effects of increase in volume and improvement in sound quality. However, there is great characteristics variation around 5000 Hz, which is insufficient in light of improvement in high frequency characteristics. That is, the configuration in which the sound output hole 15 is provided at the horizontally outward position with respect to the speaker axis (x) allows effects of the improved sound quality and volume to be produced particularly in an intermediate frequency domain of 500 to 2000 Hz.

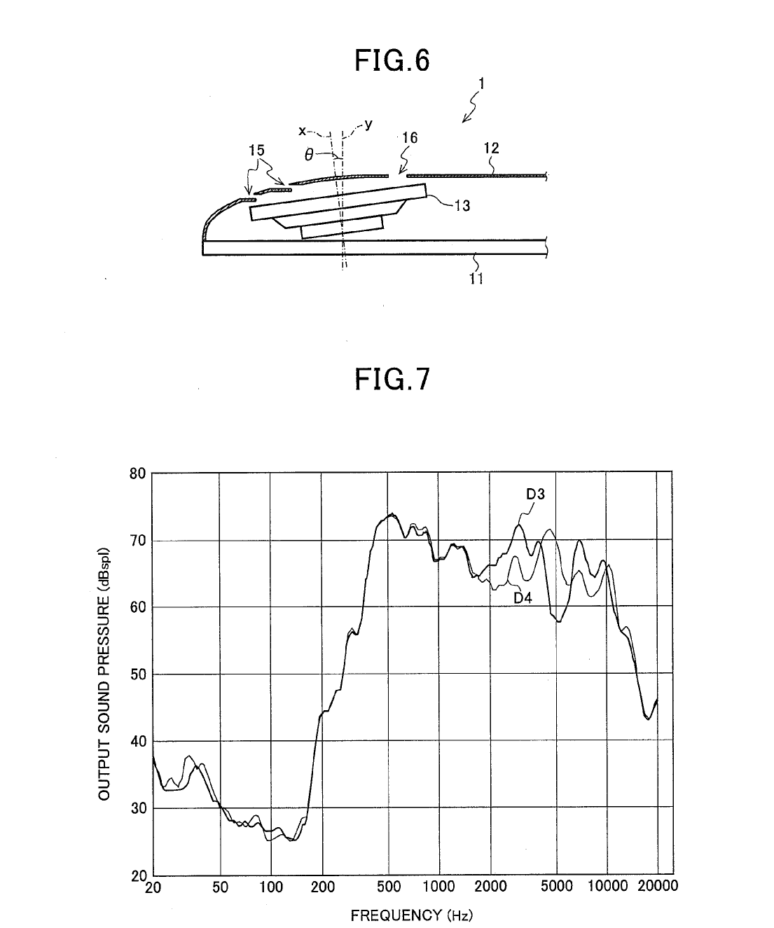

FIG. 6 is a diagram showing another embodiment of the display device of the present invention, and schematically shows the arranged configuration of the display panel, the housing and the speaker of the display device.

As described above, in the configuration in which the speaker axis (x) is inclined toward the outside in the horizontal direction of the display panel 1 with respect to the normal line (y) on the display surface of the display panel 11, the sound output hole 15 is provided at the horizontally outward position with respect to the speaker axis (x), so that there has been improvement of variation in a frequency band of about 600 Hz to 3 kHz. As shown in FIG. 6, in the present embodiment, one or more auxiliary sound output holes 16 are also provided on the inner side in the horizontal direction of the display device 1 with respect to the sound output hole 15.

In the configuration of FIG. 4, because the sound output hole 15 is laterally provided on the outer side of the housing 12, many of sounds output from the speaker 13 reach an inner face of the housing 12 at first to be extended and propagated along the inner face, and emitted toward the outside from the sound output hole 15. In this case, in a lower frequency area, relatively less disorder in sound pressure is caused due to diffraction characteristics, while disorder in frequency characteristics is caused in a high-frequency area of about 2 to 8 kHz, for example.

In the present embodiment, the auxiliary sound output hole 16 is provided to emit a part of a sound output from the speaker 13 directly to the rear-face side of the display device 1 from the front of the speaker. This makes it possible to further compensate variation in sounds in a high-frequency area that are emitted from the sound output hole 15 to improve frequency characteristics.

In this case, the enlarged opening area of the auxiliary sound output hole 16 causes the same behavior as that of the conventional configuration as shown in FIG. 1, thereby having degraded characteristics of a low-frequency area as well as a sound in a lower sound pressure level. Therefore, sounds are mainly emitted from the sound output hole 15 laterally provided with respect to the speaker axis (x), and the opening area of the auxiliary sound output hole 16 is decided from the viewpoint that a high-frequency area of the sound from the sound output hole 15 is compensated. At least the opening area of the auxiliary sound output hole 16 is made smaller than the opening area of the sound output hole 15. For example, in the case of having the sound output hole 15 in a slit shape with fixed width and length, the auxiliary sound output hole 16 is formed in a slit shape with width narrower than the sound output hole 15.

FIG. 7 is a diagram showing a measurement result of sound pressure of a sound output from a speaker in a configuration shown in FIG. 6 in which a sound output hole and an auxiliary sound output hole are provided.

In FIG. 7, D4 indicates frequency characteristics of the provided sound output hole 15 and auxiliary sound output hole 16 that are shown in FIG. 6, and a detection result D3 in the configuration of FIG. 4 is displayed for comparison. D3 is the same as D3 shown in FIG. 5. Also in this example, the angle θ of the speaker axis (x) with respect to the normal line (y) is 7°.

As shown in FIG. 7, in the configuration in which the speaker axis (x) is inclined toward the outside in the horizontal direction of the display panel 11 with respect to the normal line (y) of the display surface of the display panel, the sound output hole 15 is provided at the horizontally outward position with respect to the speaker axis (x), and the auxiliary sound output hole 16 is provided on the horizontally inner side with respect to the sound output hole 15, so that it is possible to reduce variation particularly in a high-frequency band of 2000 Hz or more, thereby showing effects of improvement in sound quality. In the example of FIG. 7, variation in sound pressure from 2000 to 80000 Hz is indicated as 15 dB in D3 having only the sound output hole 15, while decreasing to 10 dB in D4 including the sound output hole 15 and the auxiliary sound output hole 16, thereby improving frequency characteristics.

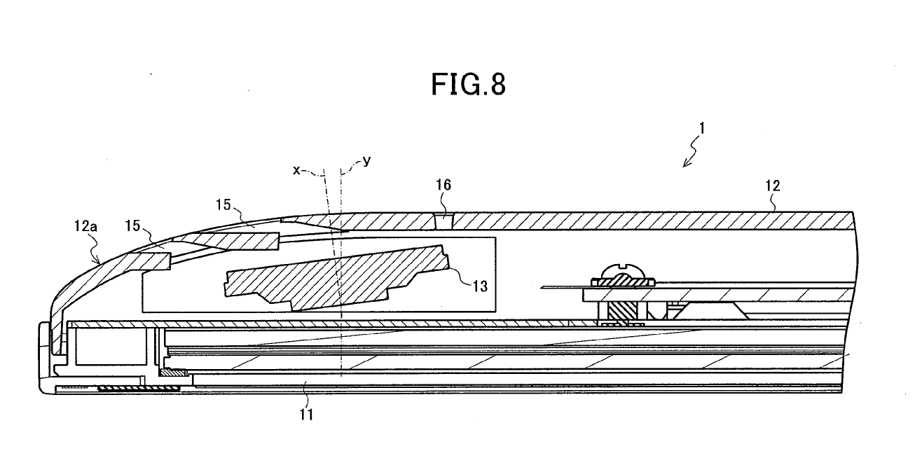

FIG. 8 is a diagram showing a more specific configuration example of an embodiment of the display device according to the present invention, and shows a more specific configuration example of the configuration schematically shown in FIG. 6.

In the configuration of FIG. 8, a plurality of the sound output holes 15 are provided at horizontally outward positions with respect to the speaker axis (x), and a plurality of the auxiliary sound output holes 16 are also provided on the inner side in the horizontal direction of the display device 1 with respect to the sound output hole 15 in the configuration in which the speaker axis (x) is inclined toward the outside in the horizontal direction of the display panel 11 with respect to the normal line (y) on the display surface of the display panel.

The sound output from the speaker 13 is emitted to the outside of the housing 12 from the sound output hole 15 provided on the horizontally outer side of the speaker axis (x). Thereby, sound quality (frequency characteristics) and volume of a sound diffracted to a front user side from the lateral direction of the display device 1 are improved, and the sound quality and volume characteristics particularly in an intermediate frequency domain of about 500 to 2000 Hz are improved. Additionally, the auxiliary sound output hole 16 is also provided, thereby improving sound quality particularly in a high-frequency area of 2000 Hz or more, so that it is possible to emit a sound to a user with favorable sound quality and a favorable volume level.

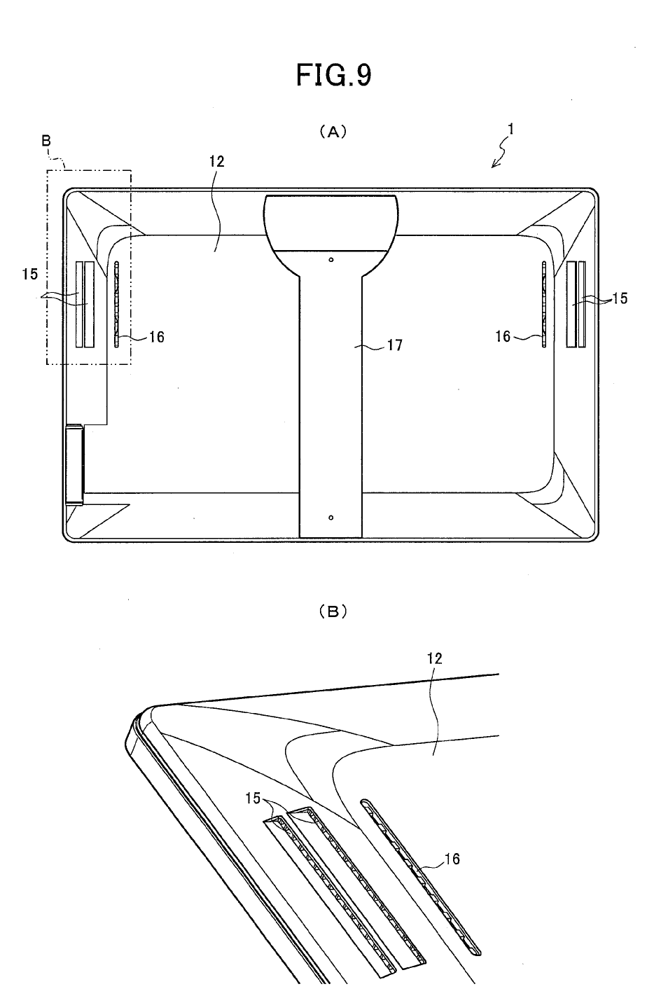

FIG. 9 is a diagram showing the rear-face side of the display device having the configuration of FIG. 8, in which FIG. 9(A) is an entire back view of the display device 1 and FIG. 9(B) is a perspective view of a portion where the sound output hole and the auxiliary sound output hole in FIG. 9(A) are provided.

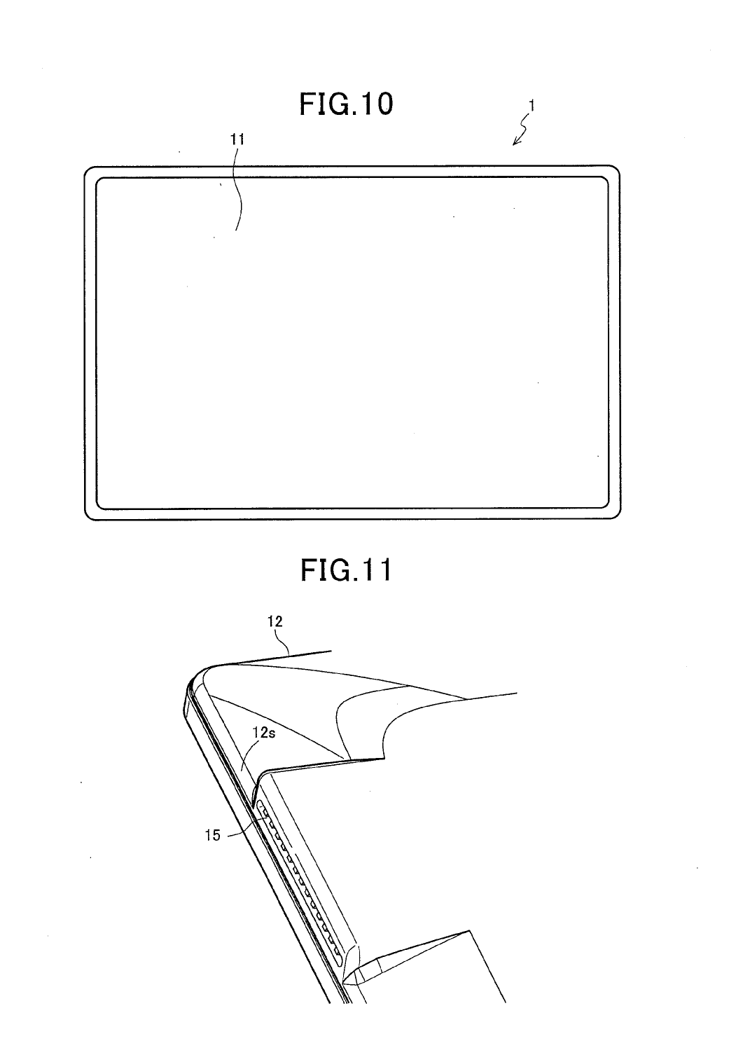

The display device 1 of this example is formed so as to enable erecting and placing on a desk or the like by a stand 17 rotatable with hinges. FIG. 10 is a diagram showing a face opposite to the display device 1 (front side of the display device 1), in which almost the entire front side of the display panel 11 serves as a display screen.

The speakers 13 are provided in two places of top right and top left of the display device 1, and in each of these places, one or more speakers 13 are arranged. Additionally, as shown in FIG. 8, the sound output holes 15 are provided at outward positions in the horizontal direction of the display device 1 with respect to a speaker axis of each speaker 13. In this example, a plurality of rectangular openings of the sound output holes 15 are arrayed on a straight line, thereby entirely forming an opening portion in a slit shape. Further, the opening portions in the slit shape are arranged in two lines.

Moreover, the auxiliary sound output holes 16 are provided on the inner side in the horizontal direction of the display device 1 with respect to the sound output hole 15. A plurality of rectangular openings of the auxiliary sound output holes 16 are also arrayed on a straight line, thereby entirely forming an opening portion in a slit shape. Further, horizontal width of each rectangular opening of the auxiliary sound output hole 16 is narrower than width of the sound output hole 15, thereby entirely having an opening area of the auxiliary sound output hole 16 smaller than an opening area of the sound output hole 15.

Such a configuration makes it possible to output a sound with favorable sound quality and volume, while inhibiting degradation in frequency characteristics and reduction in volume in a configuration in which a speaker is provided on the rear-face side of a display panel.

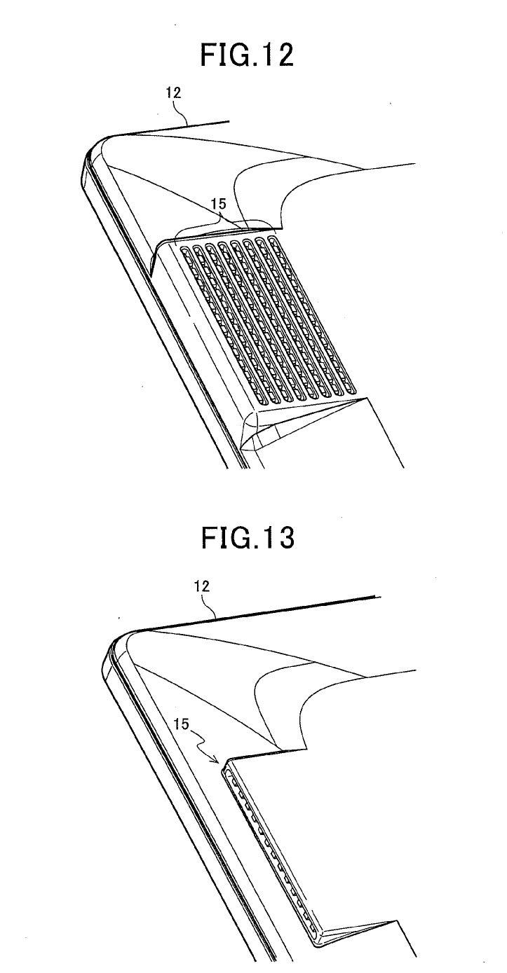

FIG. 11 is a diagram showing another configuration example of the sound output hole in the display device according to the present invention, corresponding to the perspective view of the portion of FIG. 9(B). The example of FIG. 11 is intended to contribute to improvement in sound quality and volume by including only the sound output holes 15. In this example, a side wall portion 12s of the housing 12 is configured to have a surface vertical to a display panel, and rectangular openings of the sound output holes 15 are configured to be arrayed on a straight line on a lateral face of the housing 12. Because the sound output holes 15 are further located at horizontally outward positions with respect to the speaker axis (x) compared to the above-described configuration example of FIG. 9, sound pressure toward the lateral side of the display device 1 is enhanced, thereby having many sounds diffracted to the front, so that sound pressure characteristics at a front user position are enhanced.

FIG. 12 is a diagram showing another configuration example of the sound output hole in the display device according to the present invention, corresponding to the perspective view of the portion of FIG. 9(B). The example of FIG. 12 is intended to contribute to improvement in sound quality and volume by including only the sound output holes 15. In this example, the sound output holes 15 are formed in a plurality of lines of rectangular openings that are arrayed on the straight line. The sound output hole 15 is designed in a shape like a louver.

FIG. 13 is a diagram showing still another configuration example of the sound output hole in the display device according to the present invention, corresponding to the perspective view of the portion of FIG. 9(B). The example of FIG. 13 is intended to contribute to improvement in sound quality and volume by including only the sound output holes 15, in which the sound output holes 15 are configured to have rectangular openings that are arrayed on a straight line. A central axis of the sound output hole 15 that is formed by each rectangle faces approximately lateral direction of the display device 1.

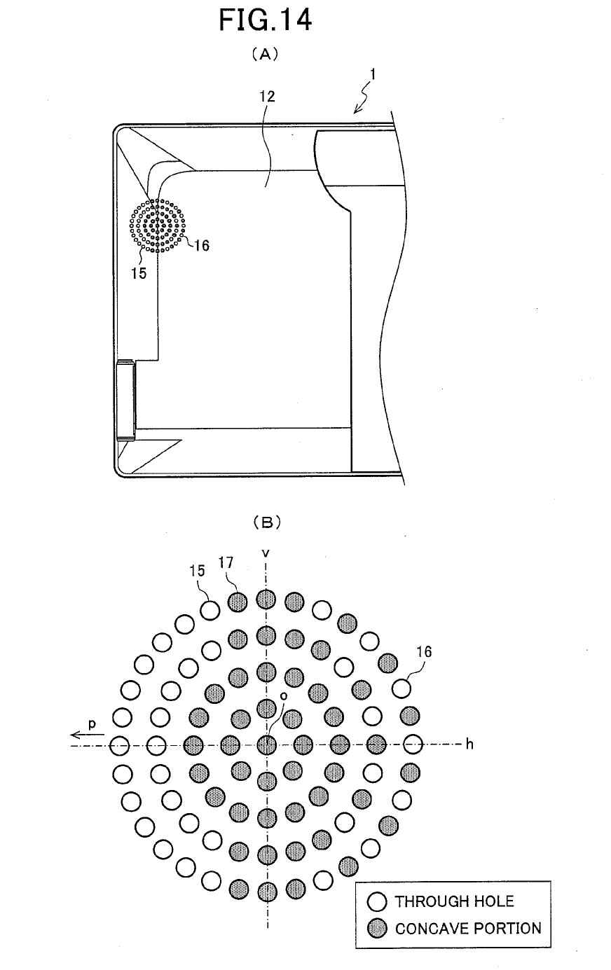

FIG. 14 is a diagram showing another configuration example of the sound output hole and the auxiliary sound output hole in the display device of the present invention, in which FIG. 14(A) is a diagram showing almost half of the rear-face side of the display device while FIG. 14(B) is a diagram showing a configuration example of the sound output hole and the auxiliary sound output hole shown in FIG. 14(A).

Not-shown speakers are provided in two places of top right and top left of the display device 1. Moreover, as shown in FIG. 14(A), a plurality of sound output holes 15 and auxiliary sound output holes 16 are provided on a wall surface of the housing 12 facing the speakers.

In the case of the present example, the respective sound output holes 15 and auxiliary sound output holes 16 are composed of a plurality of circular through holes, and these through holes are arranged on a concentric circle. To give description with reference to FIG. 14(B), a virtual center of the concentric circle is assumed to be (o). (o) is located on an intersection point of an h-axis coinciding with the horizontal direction of the display device and a v-axis coinciding with the vertical direction thereof. The outside in the horizontal direction of the display panel 11 is in a direction shown by an arrow (P).

Having the intersection point (o) coincided with the speaker axis serving as a center of directivity of the speaker, a plurality of through holes are then provided on the concentric circle so that the holes fit into a circular shape of the diaphragm of the speaker. In this case, although it is not essential to have the speaker axis and the intersection point (o) strictly coincided with each other, the through holes are preferably arranged in conformity to a shape of the diaphragm on the front side of the diaphragm of the speaker. That is, the sound output holes 15 and the auxiliary sound output holes 16 are arranged within a region of the housing located in front of the diaphragm of the speaker, the region being in a shape corresponding to the shape of the diaphragm. Accordingly, a sound output from the speaker is allowed to be emitted to the outside of the housing effectively from the sound output holes 15 and the auxiliary sound output holes 16 arranged in front of the diaphragm of the speaker.

In this example, the sound output holes 15 for outputting the sound from the speaker to the outside are provided at the outward position in the horizontal direction of the display panel 1 with respect to the intersection point (o) through which the speaker axis passes. The sound output holes 15 are composed of a plurality of through holes arranged on the outer side in a P direction with respect to the v-axis of FIG. 14(B), and shown with white circles in the figure.

On the other hand, a plurality of the auxiliary sound output holes 16 are provided at the horizontally inward position with respect to the intersection point (o) through which the speaker axis passes. The auxiliary sound output holes are composed of a plurality of through holes arranged on the inner side (opposite to the P direction) with respect to the v-axis of FIG. 14(B), and shown with white circles in the figure.

The total opening area of all the auxiliary sound output holes 16 is set to be smaller than the total opening area of all the sound output holes 15. This makes it possible to compensate variation in a high-frequency area of the sound emitted from the sound output holes 15 and improve frequency characteristics. Moreover, the number and the area of the through holes constituting the sound output holes 15 as well as the number and the area of the through holes constituting the auxiliary sound output holes 16 are changed, thereby making it possible to make an adjustment so that optimal frequency characteristics are obtained in accordance with a shape, use environment and the like of a display panel.

Further, in FIG. 14, a concave portion 17, shown with a black circle other than white circles showing the sound output holes 15 and the auxiliary sound output holes 16, is bored halfway in the thickness direction of the housing without penetrating the wall portion of the housing of the display panel 1. Since a plurality of concave portions 17 are provided in space on the concentric circle where the sound output hole 15 and the auxiliary sound output hole 16 are not arranged, it appears that holes are provided on the concentric circle in conformity to the shape of the speaker, and thereby a design effect is obtained. Accordingly, it is not essential to provide the concave portion 17, and, for example, a region without the sound output hole 15 and the auxiliary sound output hole 16 may be processed to be in a flat state.

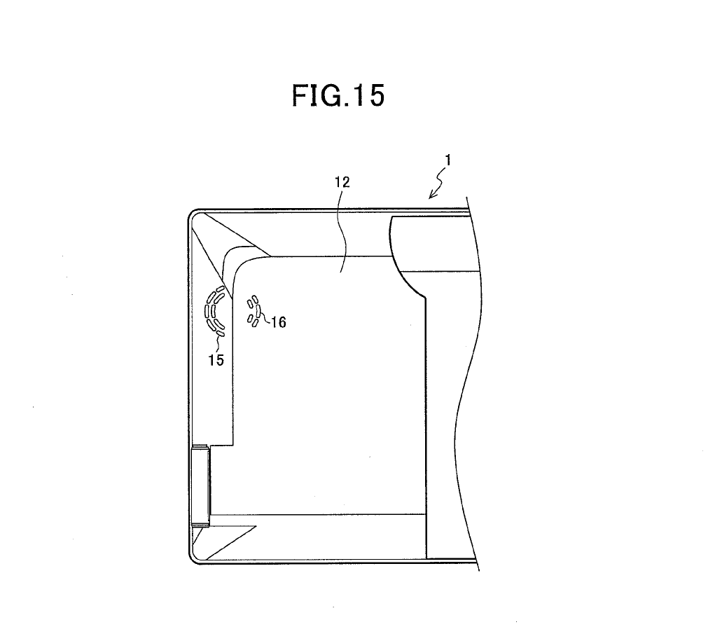

FIG. 15 is a diagram showing still another configuration example of the sound output hole and the auxiliary sound output hole in the display device of the present invention, the diagram showing almost half of the rear-face side of the display device. In the present example, a plurality of the sound output holes 15 and the auxiliary sound output holes 16 are provided on the wall surface of the housing 12 facing the speaker similarly to FIG. 14, however, being different from the example of FIG. 14, a shape of each of the sound output holes 15 and the auxiliary sound output holes 16 is an elongated slit shape. In the present example, each of the sound output holes 15 and the auxiliary sound output holes 16 has a shape of a curved oval.

At the time, the sound output hole 15 is provided at the outward position in the horizontal direction of the display panel 1 with respect to the intersection point (o) through which the speaker axis passes, and a plurality of auxiliary sound output holes 16 are provided at the horizontally inward positions with respect to the intersection point (o) through which the speaker axis passes, and then arranged so that a major-axis direction of the curved oval coincides with a circumferential direction of the concentric circle.

The shape of the hole in the present example shows an example of variations of an opening shape of each of the sound output hole 15 and the auxiliary sound output hole 16, and the present invention is not limited to the shapes so that it is possible to appropriately design shapes of the sound output hole 15 and the auxiliary sound output hole 16, then the number and the area of the sound output holes 15 and the auxiliary sound output holes 16 are adjusted, so that sound emission characteristics of the sound output hole 15 and compensation characteristics by the auxiliary sound output hole 16 are allowed to be optimized. Further, also in this case, a concave portion having the same shape as the sound output hole 15 and the auxiliary sound output hole 16 may be provided in vacant space on the concentric circle to give a design effect.

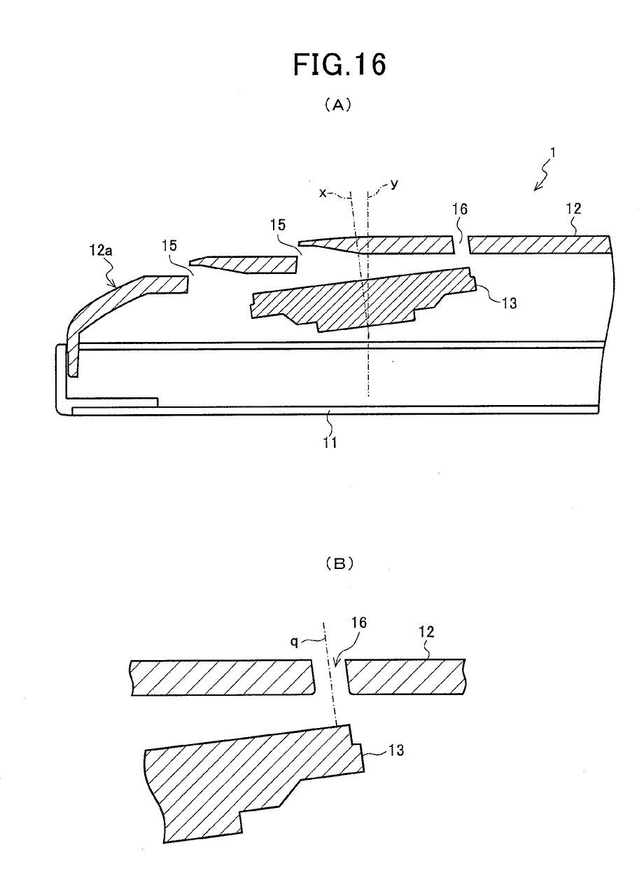

FIG. 16 is a diagram showing a setting example of a shape of the auxiliary sound output hole in the display device according to the present invention, in which FIG. 16(A) is a diagram showing a configuration example of a portion including the speaker of the display device while FIG. 16(B) is an enlarged diagram of a cross-section of the auxiliary sound output hole 16 shown in FIG. 16(A). In the display device 1, the speaker axis (x) of the speaker 13 is inclined toward the outside in the horizontal direction of the display panel 11 with respect to the normal line (y) on the display surface of the display panel 11. Additionally, a plurality of sound output holes 15 are provided at the horizontally outward position with respect to the speaker axis (x), and a plurality of auxiliary sound output holes 16 are provided on the inner side in the horizontal direction of the display device 1 with respect to the sound output hole 15.

In the present example, a sound output from the speaker 13 is emitted to the outside of the housing 12 from the sound output hole 15 provided on the horizontally outer side with respect to the speaker axis (x). Moreover, the sound is output toward the rear face of the housing 12 by the auxiliary sound output hole 16. Here, the central axis (q) of the auxiliary sound output hole 16 in the present example is inclined in the lateral direction of the display device 1. The central axis (q) is specified by a wall surface shape around the auxiliary sound output hole 16, and, for example, when the auxiliary sound output hole 16 forms space in the shape of a column or a prism, a long axial center of the column or the prism is the central axis (q). The direction of the central axis (q) is inclined in the lateral direction of the display device 1 with respect to the normal line (y) of the display panel. Accordingly, when a sound emitted from the speaker 13 is emitted through the auxiliary sound output hole 16, the sound is emitted in the lateral direction of the display device 1 along the direction of the inclined central axis (q), so that a sound diffracted to the front side of the display device 1 increases, thereby allowing sound pressure characteristics at a front user position to be enhanced.

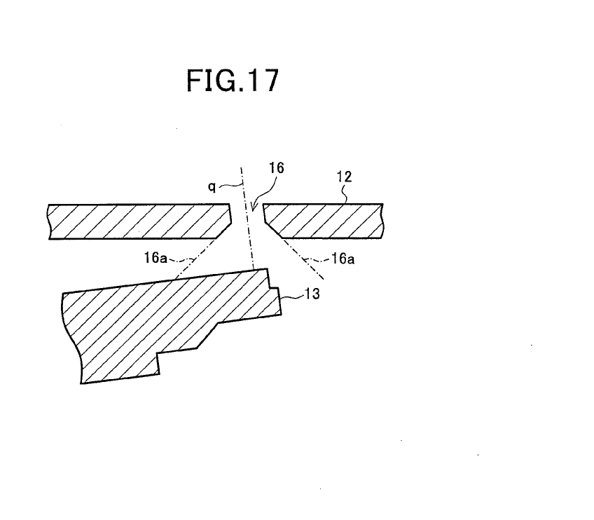

FIG. 17 is a diagram showing yet still another configuration example of the auxiliary sound output hole. Regarding the auxiliary sound output hole 16, the central axis (q) of the auxiliary sound output hole 16 is inclined in the lateral direction of the display device 1 with respect to the normal line (y) on the display panel similarly to the configuration of FIG. 16. Further, in the case of the configuration of the present example, the inward side of the housing of the auxiliary sound output hole 16 is subjected to counterboring. That is, an inclined surface 16a by counterboring is formed on an opening portion on the inward side of the housing of the auxiliary sound output hole 16. Such a configuration makes it possible to expect that a sound output from the speaker 13 inside the housing 12 is more effectively collected to be emitted from the auxiliary sound output hole 16.

In the above example, the central axis (q) of the auxiliary sound output hole 16 is inclined in the lateral direction of the display device 1, and the sound output hole 15 is also allowed to have the same configuration. For example, the central axis (q) of the sound output hole 15 faces the lateral direction of the display device 1 from the beginning in the case of the configuration as shown in FIG. 8, however, in a case where the sound output hole 15 is provided with the configuration as shown in FIG. 9, it may be configured so that a central axis of each of the sound output holes 15 is allowed to face the lateral direction of the display device 1. This increases a sound which is emitted from the sound output hole 15 to be diffracted to the front side, allowing sound pressure characteristics at a front user position to be enhanced.

Moreover, the counterboring described above is also allowed to be applied to the sound output hole 15. That is, the inclined face is provided by counterboring on the opening portion on the inward side of the housing of the sound output hole 15, making it possible to expect that a more effective sound collecting effect is achieved.

As described above, in the embodiments according to the present invention, the device may be configured to be provided with the sound output hole 15, and may be further configured to be provided with the sound output hole 15 and the auxiliary sound output hole 16 for improving sound quality.

It is clear that the sound output hole 15 and the auxiliary sound output hole 16 are not limited to the above-described configuration, and may be set appropriately without departing from the present invention.

### EXPLANATIONS OF LETTERS OR NUMERALS

1 . . . display device; 11 . . . display panel; 12 . . . housing; 12s . . . side wall portion; 13 . . . speaker; 13 . . . housing; 14 . . . sound output hole; 15 . . . sound output hole; 16 . . . auxiliary sound output hole; and 17 . . . stand.

1-10. (canceled)

11. A display device, comprising:
a display panel for displaying an image;
a housing to which the display panel is attached; and
a speaker provided inside the housing on a rear-face side of the display panel, wherein
a speaker axis of the speaker is inclined toward the outside in a horizontal direction of the display panel with respect to a normal line to a display surface of the display panel, and a center of directivity of the speaker is arranged outward and obliquely rearward the display device;
the housing has one or more sound output holes for outputting a sound emitted from the speaker to the outside, the sound output hole being located at an outward position in the horizontal direction of the display panel with respect to the speaker axis;
the housing has one or more auxiliary sound output holes on the inner side in the horizontal direction of the display device with respect to the sound output hole; and
an opening area of the auxiliary sound output hole is smaller than an opening area of the sound output hole.

12. The display device as defined in claim 11, wherein
the housing includes a rear-face wall portion arranged parallel to the display panel on a rear-face side of the display panel and a side wall portion that connects the rear-face wall portion and the display panel on a lateral side in the horizontal direction of the rear-face wall portion, and the sound output hole is provided on the side wall portion.

13. The display device as defined in claim 12, wherein
the auxiliary sound output hole is provided on the rear-face wall portion.

14. The display device as defined in claim 11, wherein
a central axis of the sound output hole specified by a wall surface shape around the sound output hole faces a lateral direction of the display device.

15. The display device as defined in claim 11, wherein
a central axis of the auxiliary sound output hole specified by a wall surface shape around the auxiliary sound output hole faces the lateral direction of the display device.

16. The display device as defined in claim 14, wherein
an inclined portion by counterboring is included on an opening portion on an inward side of the housing of the sound output hole and/or the auxiliary sound output hole.

17. The display device as defined in claim 11, wherein
the sound output hole and the auxiliary sound output hole are arranged within a region of the housing located in front of a diaphragm of the speaker, the region being in a shape corresponding to a shape of the diaphragm.

18. A display device, comprising:
a display panel for displaying an image;
a housing to which the display panel is attached; and
a speaker provided inside the housing on a rear-face side of the display panel, wherein
a speaker axis of the speaker is inclined toward the outside in a horizontal direction of the display panel with respect to a normal line to a display surface of the display panel, and a center of directivity of the speaker is arranged outward and obliquely rearward the display device;
the housing includes: a rear-face wall portion arranged parallel to the display panel on a rear-face side of the display panel; and
a side wall portion that connects the rear-face wall portion and the display panel on a lateral side in the horizontal direction of the rear-face wall portion;
the side wall portion is provided with one or more sound output holes for outputting a sound emitted from the speaker to the outside, the sound output hole being located at an outward position in the horizontal direction of the display panel with respect to the speaker axis; and
the rear-face wall portion is provided with one or more auxiliary sound output holes on the inner side in the horizontal direction of the display device with respect to the sound output hole.

19. The display device as defined in claim 18, wherein
a central axis of the auxiliary sound output hole specified by a wall surface shape around the auxiliary sound output hole faces the lateral direction of the display device.

20. The display device as defined in claim 18, wherein
the sound output hole and the auxiliary sound output hole are arranged within a region of the housing located in front of a diaphragm of the speaker, the region being in a shape corresponding to a shape of the diaphragm.
